(19) United States
(12) Patent Application Publication
(10) Pub. No.: US 2005/0068917 A1
(43) Pub. Date: Mar. 31, 2005

(54) Providing and maintaining F-PDCH service in a mobile communication system

(76) Inventor: Shahab M. Sayeedi, Naperville, IL (US)

Correspondence Address: MOTOROLA, INC., 1303 EAST ALGONQUIN ROAD, IL01/3RD, SCHAUMBURG, IL, 60196, US

(21) Appl. No.: 10/728,052

(22) Filed: Dec. 4, 2003

Related U.S. Application Data
(60) Provisional application No. 60/503,686, filed on Sep. 17, 2003.

(51) Int. Cl. H04Q 7/00

(52) U.S. Cl. 370/328

(57) ABSTRACT

Various embodiments are described herein to address the need for providing and maintaining F-PDCH service to an MS (103). Upon receiving an indication that the MS intends to switch from a F-PDCH of a serving cell (132) to a F-PDCH of a target cell (142) for continued data transmission service, the network equipment (e.g., BSs 120, 130, and/or 140) determines whether the target cell is presently available to provide the F-PDCH service to the MS. When the selected cell is not able to support F-PDCH service for the MS (e.g., because of F-PDCH loading, quality of service requirements, etc.), the network equipment sends an indication to the MS that the target cell is presently unavailable to provide F-PDCH data transmission service to the MS. Thus, the MS is able to abort switching to the selected cell and prevent loosing its F-PDCH service as a result.

### REFERENCES(S) TO RELATED APPLICATION(S)

The present application claims priority from provisional application, Ser. No. 60/503,686, entitled “PROVIDING AND MAINTAINING F-PDCH SERVICE IN A MOBILE COMMUNICATION SYSTEM,” filed Sep. 17, 2003, which is commonly owned and incorporated herein by reference in its entirety.

### FIELD OF THE INVENTION

The present invention relates generally to mobile communication systems and, in particular, to providing and maintaining F-PDCH service in mobile communication systems.

### BACKGROUND OF THE INVENTION

An IS-2000-C mobile with an active 1xEV-DV call (RC 10) receives packet data in the forward direction on an F-PDCH from a single serving cell in its active set. The mobile measures the pilot strength of its current serving cell, i.e. the cell which has allocated F-PDCH resources to the mobile, and reports Carrier/Interference (C/I) measurements for the cell every 1.25 ms on the R-CQICH channel with the serving cell's CQICH_COVER applied. The mobile also monitors the pilot strength of other cells/sectors in its active set.

When the mobile station determines that a stronger target cell in the active set (which supports an F-PDCH) is available than the current serving cell, the mobile station initiates a sector/cell switching procedure by transmitting a distinctive switching pattern on the R-CQICH for a fixed number of 20 ms frames (16 slots per frame) as specified by NUM_SOFTER_SWITCHING_FRAMES or NUM_SOFT_SWITCHING_FRAMES parameters. During the switching period, the mobile's R-CQICH transmission is modified to include the target cell's CQICH_COVER in a specified number of 1.25 ms slots within the 20 ms frame as specified by the TIA-2000-C CQI repetition, number of switching slots, and pilot gating parameters (REV_CQICH_REPS, NUM_SOFT/SOFTER_SWITCHING_SLOT etc) in addition to the current serving cell's CQI in the non-switching slots. See TIA-2000.3-C and TIA-2000.5-C for details.

This is known as cell selection and signals the mobile's intention to switch to the stronger target cell to receive its F-PDCH data transmission. The serving and target cells may be controlled by the source BSC for the call (with anchored SDU) or a different ‘target’ BSC see TIA-2001-C for details). After transmitting the switching pattern for the specified period of time, the mobile stops monitoring the F-PDCCH of the serving cell for its data and begins to monitor the F-PDCCH/F-PDCH transmission of the target cell for its data. Unlike other traffic channels that are assigned by the network, the mobile selects the F-PDCH on its own. If for any reason the selected target cell is unable to allocate resources to the mobile (F-PDCH capacity, QoS requirements, user subscription, backhaul load, etc.), TIA-2000-C doesn't specify a procedure that allows the network to stop a mobile from selecting and switching over to the target cell's F-PDCH resources. The standard allows the MS to switch to a stronger target cell without any air interface signaling from the network to confirm or reject the cell selection and switching. In the event the target cell is unable to support the mobile's call, forward data transmission to the mobile may deteriorate or end resulting in the failure of the packet data call.Thus, a need exists for an apparatus and method for providing and maintaining F-PDCH service when a selected cell is unable to support a mobile's continuing call.

### BRIEF DESCRIPTION OF THE DRAWINGS

FIG. 1 is a depiction of a mobile communication system in accordance with multiple embodiments of the present invention.

FIG. 2 is a messaging flow diagram in accordance with a first embodiment of the present invention.

FIG. 3 is a messaging flow diagram in accordance with a second embodiment of the present invention.

FIG. 4 is a messaging flow diagram in accordance with a third embodiment of the present invention.

FIG. 5 is a messaging flow diagram in accordance with a fourth embodiment of the present invention.

### DETAILED DESCRIPTION OF EMBODIMENTS

Various embodiments are described herein to address the need for providing and maintaining F-PDCH service to an MS. Upon receiving an indication that the MS intends to switch from a F-PDCH of a serving cell to a F-PDCH of a target cell for continued data transmission service, the network equipment determines whether the target cell is able to provide the F-PDCH service to the MS. When the selected cell is not able to support F-PDCH service for the MS (e.g., because of F-PDCH loading, MS data rate requirements, quality of service requirements, user subscription issues, etc.), the network equipment sends an indication to the MS that the target cell is presently unavailable to provide F-PDCH data transmission service to the MS. Thus, the MS is able to abort switching to the selected cell and prevent loosing its F-PDCH service as a result.

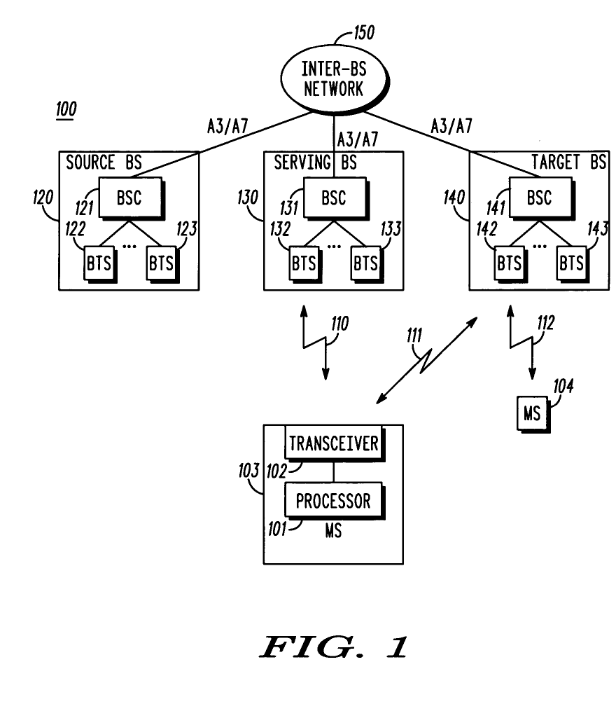

The disclosed embodiments can be more fully understood with reference to FIGS. 1-5. FIG. 1 is a block diagram depiction of a mobile communication system 100 in accordance with multiple embodiments of the present invention. Communication system 100 is a well-known Code Division Multiple Access (CDMA) system, specifically a cdma2000 system, which is based on the Telecommunications Industry Association/Electronic Industries Association (TIA/EIA) standards IS-2000 and IS-2001, suitably modified to implement the present invention. Alternative embodiments of the present invention may be implemented in communication systems that employ other technologies such as, but not limited to, those that provide for mobile-directed cell selection.

Those skilled in the art will recognize that FIG. 1 does not depict all of the network equipment necessary for system 100 to operate but only those system components and logical entities particularly relevant to the description of embodiments of the present invention. For example, the network equipment of system 100 comprises components such as base stations (BSs) 120, 130, and 140 and an inter-BS network 150 that supports signaling protocols such as A3 and A7. BSs are well-known to comprise components such as base station controllers (BSCs) and base transceiver systems (BTSs).

Furthermore, BTSs, such as BTSs 122, 123, 132, 133, 142, and 143, are known to provide wireless coverage areas, or cells, within which mobile stations (MSs), such as MSs 103 and 104, can obtain wireless services. Since a wireless coverage area may refer to a cell or a sector of a cell, depending on the particular implementation, the term “cell” will be understood by those skilled in the art to refer to either an omni-cell or an individual sector within a multi-sectored cell.

While MS platforms are well-known (mobile phones, computers, personal digital assistants, and gaming devices, e.g.), MS 103 comprises processor 101, transceiver 102, a keypad (not shown), a speaker (not shown), a microphone (not shown), and a display (not shown). Processors, transceivers, keypads, speakers, microphones, and displays as used in MSs are all well known in the art. For example, processors are known to comprise basic components such as microprocessors, memory devices, and/or logic circuitry. Such MS components are typically adapted to implement-algorithms that have otherwise been expressed logically, for example, in high-level design languages or descriptions, as computer instructions, and/or in logical flow diagrams. Thus, given an algorithm, a logic flow, a messaging flow, and/or a protocol specification, those skilled in the art are aware of the many design and development techniques available to implement an MS that performs the given logic. Thus, MS 103 represents a known MS that has been adapted, in accordance with the description herein, to implement embodiments of the present invention.

Likewise, while BS platforms are well-known, BSs 120, 130, and 140 are depicted in FIG. 1 as comprising BSCs 121, 131, and 141, respectively, and BTSs 122, 123, 132, 133, 142, and 143. In general, components such as BSCs and BTSs are well-known. For example, they both are known to comprise basic components such as microprocessors, memory devices, and/or logic circuitry. Thus, given an algorithm or a logic flow, those skilled in the art are aware of the many design and development techniques available to implement a processor and network interface that perform the given logic. Thus, BSs 120, 130, and 140 represent known BSs that have been adapted, in accordance with the description herein, to implement embodiments of the present invention.

BSs 130 and 140 (specifically BTSs 132 and 142) communicate with MSs 103 and 104 via air interfaces 110 and 112, respectively. Air interfaces 110 and 112 each comprise a forward link (not shown) having multiple communication channels, such as a F-PDCH and a F-PDCCH, and a reverse link (not shown) having multiple communication channels, such as an R-CQICH and a reverse link access channel. Air interface 111 represents the signaling of MS103 that may also be received by BTS 142, such as R-CQICH signaling, and any fundicated signaling from BTS 142 to MS103. In multiple embodiments of the present invention, air interfaces 110-112 comprise dynamically changing groups of IS-2000 channels and IS-2000 compliant signaling, except to the extent modified by embodiments described herein.

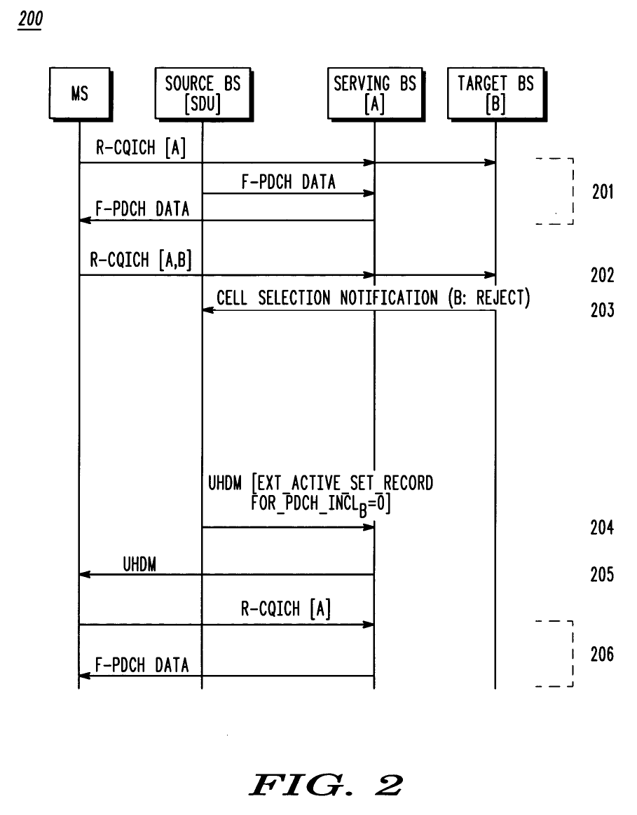

Further description of embodiments of the present invention will focus on the messaging flow diagrams of FIGS. 2-5. However, FIG. 1 serves as a valuable reference since the source, serving, and target BSs of FIGS. 2-5 are depicted as BSs 120,130, and 140, respectively. In addition, it is MS 103 that is referred to throughout as the mobile which is served by serving BS 130 and serving cell (i.e., BTS 132) and which is selecting a target cell (i.e., BTS 142) in target BS 140. While BS 140 and BTS 142 are the target BS and target cell of MS 103, they are the serving BS and serving cell for MS104. MS 104 is representative of the other MSs that BTS 142 may be providing data transmission services to via a F-PDCH. Thus, BTS 142 is F-PDCH capable, but unable to additionally support MS 103's F-PDCH needs for reasons related to F-PDCH loading, MS 103 data rate requirements, quality of service requirements, user subscription issues, etc.

In the prior art, neither the serving nor target cells are able to stop the mobile from autonomously selecting and switching to the target cell. The current TIA-2000-C specification allows an MS to switch to the stronger target without any signaling confirming or rejecting the cell selection from the network. Moreover, there are no requirements on the mobile to reselect another cell, so the call may simply be dropped. If instead the mobile reselects another cell, there will be a loss of data during this subsequent cell selection period. Thus, it would seem that the mobile is better off staying with the current serving cell or selecting an alternate cell, which may be weaker than the original selected cell but nonetheless able to support the call requirements. Embodiments of the present invention provide signaling to a mobile, such as MS 103, that indicates that a target cell or even a serving cell will not be providing or continuing to provide F-PDCH data transmission service to the MS.

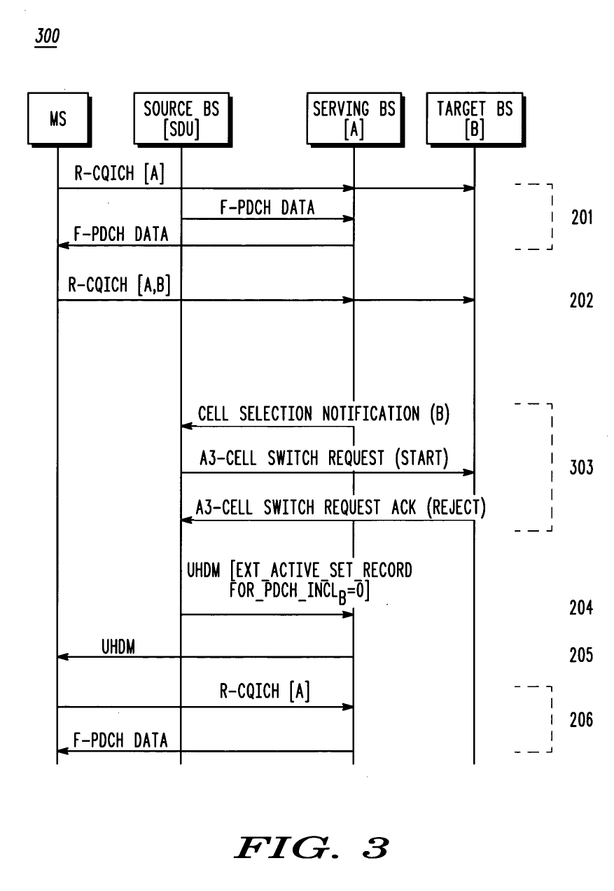

FIG. 2 is a messaging flow diagram 200 in accordance with a first embodiment of the present invention. Similarly, FIG. 3 is a messaging flow diagram 300 in accordance with a second embodiment of the present invention. Before describing the messaging flows in detail, the following points provide some context:
Cell A (BTS 132) was previously selected by the mobile (MS 103).
Cell A is receiving data from the source BSC 121, which includes the controlling Selection and Distribution Unit (SDU), via BSC-BTS signaling (such as Abis signaling) or inter-BSC signaling, and transmitting the data to the MS over its F-PDCH.
Serving Cell A and Target Cell B (from the active set) may be controlled by the same or different BSC. Source BSC (with anchored SDU) may control the serving and target cells or they may be controlled by one or more other BSCs.
In the event that cell A and/or cell B are under control of the Source BSC, signaling to the cell occurs over the BSC-BTS signaling link (Abis). If serving or target cells are controlled by different BSC(s), inter-BSC signaling occurs over A3/A7 and Target BSC-BTS links.
Serving Cell A is able to detect when target cell B has been selected by the mobile (CQICH_COVER of extended active set cells/sectors applied to the switching slots). Target cell B may also be able to determine when it has been selected by applying its own CQICH_COVER to the mobile's R-CQICH switching slots.
Source BSC initiates cell selection procedures upon cell selection notification from either serving cell A and/or target cell B (first and second embodiments).
Prior setup of A3 connections from Source BSC to Target BSC occurs when cells are added to the active set.
   Messaging 201

The mobile's R-CQICH transmission includes CQI of Cell A. Source BSC (anchored SDU) forwards packet data from PDSN to Cell A over bearer connection. Current serving cell A is sending packet data to the mobile over its F-PDCH channel.

Messaging 202

Mobile detects that target cell B's pilot which supports an F-PDCH (from current active set) has a stronger signal than current serving cell A. Mobile signals selection of cell B for its F-PDCH data transmission by applying CQICH_COVER for cell B in R-CQICH switching slots.

Next, the target cell rejects the mobile's selection. The first embodiment (FIG. 2) differs from the second embodiment (FIG. 3) in the manner in which this rejection is indicated to the source BSC.

Messaging 203

Target cell B is decoding the mobile's R-CQICH switching slots and determines that the mobile has selected it for F-PDCH transmission (after soft/softer switching frames). Target Cell B responds by signaling source BSC (with anchored SDU) that it is unable to support the mobile's packet data call (due to F-PDCH capacity, QoS, or other reasons).

Messaging 303 (see FIG. 3)

Current serving cell A detects mobile cell selection of target Cell B in its R-CQICH switching slots and signals source BSC (SDU) over signaling links to source BSC. Source BSC informs target cell B over signaling links that it has been selected by the mobile. Target cell B responds by indicating that it is unable to support the call.

Regardless how the target cell learns that it has been selected by the mobile, it indicates its rejection of the cell selection to the Source BSC for the call.

Messaging 204

Source BSC constructs an IS-2000-C Universal Handoff Direction message with modified extended active set record indicating that cell B doesn't support an F-PDCH [EXT_ACTIVE_SET_RECORD: FOR_PDCH_INCL_{B}=0, where FOR_PDCH_INCL_{B} is the field for cell B] or removes cell B entirely from the active set and forwards message to cell B over signaling link to cell B. A fast action time is selected to force the mobile to abort selection of the target cell before it performs the cell switch. Note: other target cells may also be sent the message if forward fundicated channels assigned to the call are in soft handoff (IS-2000-C channel configurations 3,4,5,6).

Messaging 205

Serving cell A sends TIA-2000.5 UHDM signaling message to mobile (over F-PDCH or forward fundicated channel).

Messaging 206

Mobile aborts selection of target cell B and does not perform cell switch to target cell B. Mobile stops applying target cell B's CQICH_COVER in the R-CQICH switching slots. Mobile may select an alternate target cell in its active set, continue selection of current serving cell, or network may perform hard handoff to a stronger target cell.

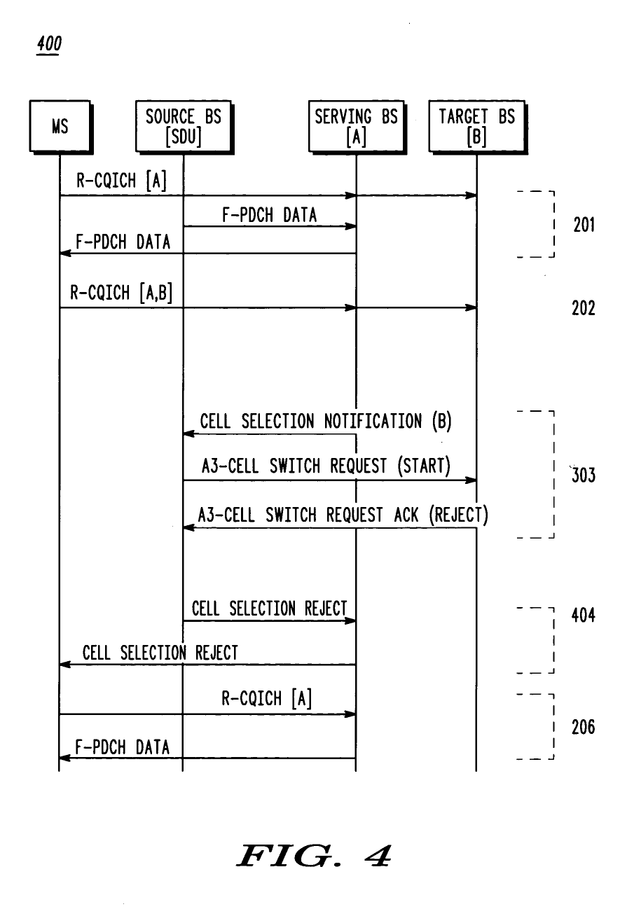

FIG. 4 is a messaging flow diagram 400 in accordance with a third embodiment of the present invention. The third embodiment differs from the first and second embodiments in the manner of indicating to the mobile that the target cell is presently unavailable to provide F-PDCH data transmission service to the MS. Instead of UHDM messaging, messaging such as that depicted in FIG. 4 (messaging 404) is used.

Messaging 404

The RAN sends a message/signal to the mobile requesting it to abort selection of the target cell. The message may additionally include a guard time period for which the selected target cell cannot be selected again. For example, the serving cell sends F-PDCCH Control channel message to the mobile having EP_SIZE=111 and EXT_MSG_TYPE set to an unused value (e.g., 11) to indicate network initiated cancellation of the mobile's current cell selection.

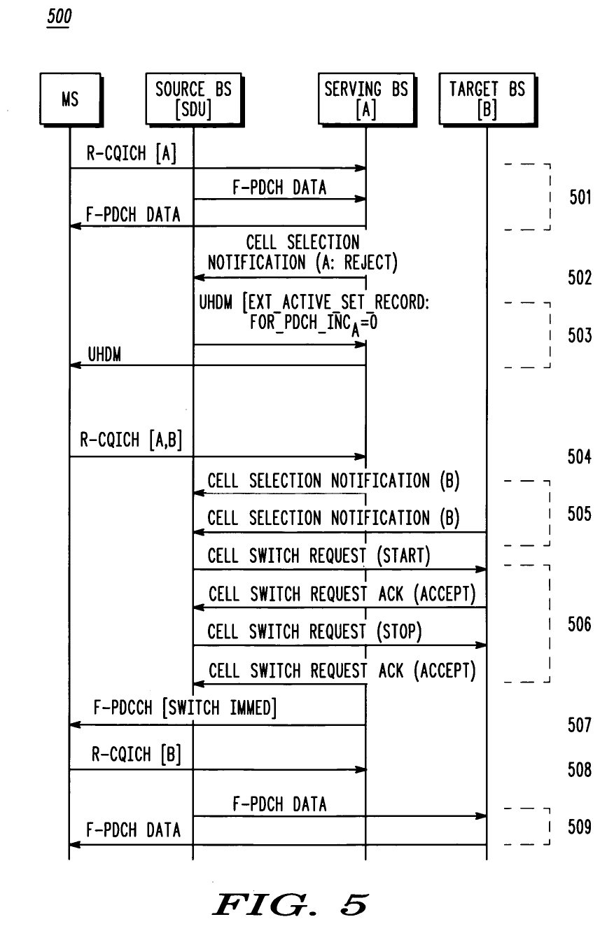

FIG. 5 is a messaging flow diagram 500 in accordance with a fourth embodiment of the present invention. The fourth embodiment illustrates an embodiment in which the mobile's serving cell indicates to the mobile that it will no longer provide F-PDCH data transmission service to the mobile.

Messaging 501

The mobile's R-CQICH transmission includes CQI of Cell A. Source BSC (anchored SDU) forwards packet data from PDSN to Cell A over bearer connection. Current serving cell A is sending packet data to the mobile over its F-PDCH channel.

Messaging 502

Serving cell A is no longer able to support the mobile's packet data call and informs the Source BSC.

Messaging 503

The network signals the mobile to abort selection of current serving cell A, the network constructs a Universal Handoff Direction message (UHDM) with modified extended active set record indicating that either cell A doesn't support a F-PDCH [EXT_ACTIVE_SET_RECORD: FOR_PDCH_INCL_{A}=0, where FOR_PDCH_INCL_{A} is the field for cell A] or removes cell A entirely from the active set. The UHDM is sent over available F-DSCH forward dedicated signal channels. This may include cell A's F-PDCH and/or forward fundicated channels by other cells in the active set. Alternatively, signaling such as that described in messaging 404 may be used to indicate to the mobile that it will no longer provide F-PDCH data transmission service to the mobile. For example, the serving cell sends F-PDCCH Control channel message to the mobile having EP_SIZE=111 and EXT_MSG_TYPE set to an unused value (e.g., 11) to indicate network initiated cancellation of the mobile's current cell selection.

Messaging 504

The mobile performs cell selection and selects another cell from its active set. The mobile begins sending CQICH_COVER of the selected cell in its R-CQICH switching slots.

Messaging 505

Source BSC is informed of the cell selection by current serving cell A and/or the selected target cell.

Messaging 506

Source BSC initiates the network cell selection procedures. Source BSC signals target cell B of the cell selection; target cell B acknowledges the cell switch.

Messaging 507

Serving cell A may send F-PDCCH control channel message to the mobile requesting it to terminate switching pattern and switch immediately to target cell B (prior to the expiration of the switching frames period).

Messaging 508

The mobile switches to target cell B and begins sending CQI for target cell B (CQICH_COVER for cell B is transmitted in all switching slots).

Messaging 509

Source BSC (SDU) sends packet data to target cell B, target cell sends the data to the mobile over its F-PDCH.

In addition to the embodiments already discussed, alternative or additional functionality may also be incorporated such as, but not limited to the following:
Upon detection (by messaging or otherwise) of a target cell's unavailability for providing additional F_PDCH services (overload condition, e.g.), the source BS generates an IS-2000 Universal Handoff Direction message (UHDM) with a modified extended active set record indicating that target BS doesn't support the F-PDCH channel (FOR_PDCH_INCL for target cell set to 0) with a fast action time. The target cell remains in the extended active set record to support any soft handoff legs required for the reverse fundicated and potentially any forward fundicated channels.
When target cell becomes available to provide additional F-PDCH services, it signals anchored source BS with a MAC_ID for the call. Source BS generates an IS-2000 Universal Handoff Direction message (UHDM) with a modified extended active set record indicating target BS support for F-PDCH channel (FOR_PDCH_INCL for target cell set to 1). Mobile may now select target cell for cell switching if needed.
When creating an active set for an MS or when soft handoff (SHO) legs are being added for the call, target indicates to source BS over A7 signaling link if it has F-PDCH capacity to support additional calls. This availability information is indicated to the MS via a UHDM message or via a channel assignment message (such as an Extended Channel Assignment message (ECAM)). The messaging may indicate that the cell does not support a F-PDCH or that the cell is not part of the active set of the MS.

In the foregoing specification, the present invention has been described with reference to specific embodiments. However, one of ordinary skill in the art will appreciate that various modifications and changes may be made without departing from the spirit and scope of the present invention as set forth in the appended claims. For example, many additional embodiments of the present invention can be implemented by making minor changes to the manner in which information is indicated in the specific messaging flows described herein. Accordingly, the specification and drawings are to be regarded in an illustrative rather than a restrictive sense, and all such modifications are intended to be included within the scope of the present invention. In addition, those of ordinary skill in the art will appreciate that the elements in the drawings are illustrated for simplicity and clarity, and have not necessarily been drawn to scale. For example, the dimensions of some of the elements in the drawings may be exaggerated relative to other elements to help improve an understanding of the various embodiments of the present invention.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims. As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The term program, as used herein, is defined as a sequence of instructions designed for execution on a computer system. A program, or computer program, may include a subroutine, a function, a procedure, an object method, an object implementation, an executable application, an applet, a servlet, a source code, an object code, a shared library/dynamic load library and/or other sequence of instructions designed for execution on a computer system.

1. A method for providing forward link packet data service to mobile stations (MSs) in a mobile communication system, the method comprising:
providing, by a cell in the mobile communication system, data transmission services via a forward link;
indicating to an MS that the cell will not provide data transmission service to the MS via the forward link.

2. The method of claim 1,
wherein providing data transmission services comprises providing data transmission services to the MS and wherein indicating that the cell will not provide data transmission service to the MS comprises indicating, by the cell, that the cell will no longer provide data transmission service to the MS via the forward link.

3. The method of claim 1,
wherein indicating to the MS that the cell will not provide data transmission service to the MS via the forward link comprises sending a channel assignment message to the MS that indicates that the cell does not support a forward link.

4. The method of claim 1,
wherein indicating to the MS that the cell will not provide data transmission service to the MS via the forward link comprises sending a channel assignment message to the MS that indicates that the cell is not part of an active set of the MS.

5. The method of claim 1, further comprising
determining whether the cell is presently available to provide data transmission service to the MS via the forward link of the cell;

6. The method of claim 5,
wherein determining whether the cell is presently available comprises determining, when creating an active set for the MS, whether the cell is presently available to provide data transmission service to the MS via the fonward link of the cell.

7. The method of claim 5,
wherein determining whether the cell is presently available to provide data transmission service to the MS via the forward link of the cell comprises requesting the cell to indicate the cell's availability to provide data transmission service to the MS via the forward link of the cell.

8. The method of claim 5,
wherein determining whether the cell is presently available to provide data transmission service to the MS via the forward link of the cell comprises receiving an indication that the cell is presently unavailable to provide data transmission service to the MS via the forward link of the cell.

9. The method of claim 1, further comprising:
providing, by a serving cell in the mobile communication system, data transmission services via a forward link of the serving cell,
wherein providing data transmission services by the cell comprises providing data transmission services by a selected target cell of the MS to at least one MS in the mobile communication system other than the MS,
wherein indicating that the cell will not provide data transmission service to the MS comprises indicating, by the serving cell, that the cell will not provide data transmission service to the MS via the forward link.

10. The method of claim 1, wherein providing data transmission services comprises providing data transmission services to the MS by the cell via the forward link.

11. The method of claim 10,
wherein indicating to the MS that the cell will not provide data transmission service to the MS via the forward link comprises sending, by the cell, a Universal Handoff Direction message (UHDM) that indicates that the cell does not support a forward link.

12. The method of claim 10,
wherein indicating to the MS that the cell will not provide data transmission service to the MS via the forward link comprises sending, by the cell, a Universal Handoff Direction message (UHDM) that indicates that the cell is not part of an active set of the MS.

13. The method of claim 10,
wherein indicating to the MS that the cell will not provide data transmission service to the MS via the forward link comprises signaling, by the cell, a network initiated cancellation of the MS's present cell selection of the cell indicating a need for the MS to select an alternate cell to provide data transmission service to the MS via a forward link.

14. The method of claim 10,
wherein indicating to the MS that the cell will not provide data transmission service to the MS via the forward link comprises signaling the MS via a forward packet data control channel (F-PDCCH) of the cell.

15. A method for providing forward link packet data service to mobile stations (MSs) in a mobile communication system, the method comprising:
providing, by a source base station (BS), data for transmission to an MS via a forward link;
receiving an indication that the MS intends to switch from a forward link of a serving cell to a forward link of a target cell for data transmission service;
determining whether the target cell is presently available to provide data transmission service to the MS via the forward link of the target cell;
sending an indication to the MS that the target cell is presently unavailable to provide data transmission service to the MS via the forward link of the target cell.

16. The method of claim 15,
wherein receiving the indication that the MS intends to switch comprises receiving the indication by the source BS from the MS via the serving cell and
wherein the source BS comprises the serving cell and is a serving BS of the MS.

17. The method of claim 15,
wherein receiving the Indication that the MS intends to switch comprises receiving the indication by the source BS from a serving BS and
wherein the serving BS comprises the serving cell.

18. The method of claim 15,
wherein receiving the indication that the MS intends to switch comprises receiving the indication by the source BS from a target BS and
wherein the target BS comprises the target cell.

19. The method of claim 15,
wherein determining whether the target cell is presently available to provide data transmission service to the MS via the forward link of the target cell comprises receiving an indication that the target cell is presently unavailable to provide data transmission service to the MS via the forward link of the target cell.

20. The method of claim 19,
wherein receiving the indication that the target cell is presently unavailable comprises receiving the indication from the target cell.

21. The method of claim 20,
wherein receiving the indication that the target cell is presently unavailable comprises receiving the indication from the target cell via a BSC-BTS signaling interface.

22. The method of claim 19,
wherein receiving the indication that the target cell is presently unavailable comprises receiving the indication from a target BS.

23. The method of claim 22,
wherein receiving the indication that the target cell is presently unavailable comprises receiving the indication from the target BS via an inter-BSC signaling interface.

24. The method of claim 19, further comprising:
subsequent to receiving the indication that the target cell is presently unavailable, receiving an indication that the target cell is available to provide data transmission service to the MS via the forward link of the target cell;
sending an indication to the MS that the target cell is available to provide data transmission service to the MS via the forward link of the target cell.

25. The method of claim 15,
wherein determining whether the target cell is presently available to provide data transmission service to the MS via the forward link of the target cell comprises sending an indication to a target BS that the MS intends to switch to the forward link of the target cell for data transmission service.

26. The method of claim 25,
wherein determining whether the target cell is presently available to provide data transmission service to the MS via the forward link of the target cell comprises receiving, in response to the indication that the MS intends to switch, an indication that the target cell is presently unavailable to provide data transmission service to the MS via the forward link of the target cell.

27. The method of claim 15,
wherein sending the indication to the MS that the target cell is presently unavailable to provide data transmission service to the MS via the forward link of the target cell comprises sending the indication to the MS via the serving cell.

28. The method of claim 15,
wherein sending the indication to the MS that the target cell is presently unavailable to provide data transmission service to the MS via the forward link of the target cell comprises sending the indication to the MS via a serving BS.

29. The method of claim 15,
wherein sending the indication to the MS that the target cell is presently unavailable to provide data transmission service to the MS via the forward link of the target cell comprises sending the indication to the MS via a forward packet data control channel (F-PDCCH) of the serving cell.

30. The method of claim 15,
wherein sending the indication to the MS that the target cell is presently unavailable to provide data transmission service to the MS via the forward link of the target cell comprises sending the indication to the MS via a forward fundicated channel of a cell in an active set of the MS.

31. The method of claim 15,
wherein sending the indication to the MS that the target cell is presently unavailable to provide data transmission service to the MS via the forward link of the target cell comprises sending a Universal Handoff Direction message (UHDM) that indicates that the target cell does not support a forward link.

32. The method of claim 15,
wherein sending the indication to the MS that the target cell is presently unavailable to provide data transmission service to the MS via the forward link of the target cell comprises sending a Universal Handoff Direction message (UHDM) that indicates that the target cell is not part of an active set of the MS.

33. A method for a mobile station (MS) to maintain forward link packet data service in a mobile communication system, the method comprising:
receiving, by an MS, data transmission service from a serving cell via a forward link of the serving cell;
determining, by the MS, to switch to a target cell for data transmission service via a forward link of the target cell;
transmitting, by the MS, an indication of an MS intent to switch to the target cell;
receiving, by the MS, an indication that the target cell is presently unavailable to provide data transmission service to the MS via the forward link of the target cell.

34. The method of claim 33,
wherein determining to switch to a target cell for data transmission service via a forward link of the target cell comprises performing cell selection among cells from an active set of the MS that provide forward link service.

35. The method of claim 33,
wherein transmitting the indication of the MS's intent to switch to the target-cell comprises transmitting the indication of the MS's intent to switch to the target cell using a switching pattern on a Reverse Channel Quality Indication Channel (R-CQICH) of the MS.

36. The method of claim 33,
wherein receiving the indication that the target cell is currently unavailable to provide data transmission service to the MS via the forward link of the target cell comprises receiving the indication by the MS via the serving cell.

37. The method of claim 33,
wherein receiving the indication that the target cell is currently unavailable to provide data transmission service to the MS via the forward link of the target cell comprises receiving the indication by the MS via a forward packet data control channel (F-PDCCH) of the serving cell.

38. The method of claim 33,
wherein receiving the indication that the target cell is currently unavailable to provide data transmission service to the MS via the forward link of the target cell comprises receiving the indication by the MS via the target cell.

39. The method of claim 33,
wherein receiving the indication that the target cell is currently unavailable to provide data transmission service to the MS via the forward link Ad of the target cell comprises receiving a Universal Handoff Direction message (UHDM) that indicates that the target cell does not support a forward link.

40. The method of claim 33,
wherein receiving the indication that the target cell is currently unavailable to provide data transmission service to the MS via the forward link of the target cell comprises receiving a Universal Handoff Direction message (UHDM) that indicates that the target cell is not part of an active set of the MS.

41. The method of claim 33, further comprising,
subsequent to receiving the Indication that the target cell is currently unavailable, receiving an indication that the target cell is available to provide data transmission service to the MS via the forward link of the target cell.

42. A base station (BS) comprising:
a base transceiver system (BTS)
adapted to provide communication services to a mobile station (MS), including data transmission via a forward link;
a base site controller (BSC), communicatively coupled to the BTS,
adapted to provide data for transmission by the BTS to the MS via the forward link,
adapted to receive, via the BTS, an indication that the MS Intends to switch from the forward link to a forward link of a target cell for data transmission service,
adapted to determine whether the target cell is presently available to provide data transmission service to the MS via the forward link of the target cell,
adapted to send, via the BTS, an indication to the MS that the target cell Is presently unavailable to provide data transmission service to the MS via the forward link of the target cell.

43. The BS of claim 42,
wherein adapted to determine whether the target cell is presently available to provide data transmission service to the MS via the forward link of the target cell comprises adapted to receive an Indication that the target cell is presently unavailable to provide data transmission service to the MS via the forward link of the target cell.

44. The BS of claim 42,
wherein adapted to determine whether the target cell is presently available to provide data transmission service to the MS via the forward link of the target cell comprises adapted to send an indication to a target BS that the MS intends to switch to the forward link of the target cell for data transmission service.

45. The BS of claim 42,
wherein adapted to send the indication to the MS that the target cell is presently unavailable to provide data transmission service to the MS via the forward link of the target cell comprises adapted to send, via the BTS, a Universal Handoff Direction message (UHDM) that indicates that the target cell does not support a forward link.

46. The BS of claim 42,
wherein adapted to send the indication to the MS that the target cell is presently unavailable to provide data transmission service to the MS via the forward link of the target cell comprises adapted to send, via the BTS, a Universal Handoff Direction message (UHDM) that indicates that the target cell is not part of an active set of the MS.

47. The BS of claim 42,
wherein adapted to send the indication to the MS that the target cell is presently unavailable to provide data transmission service to the MS via the forward link of the target cell comprises adapted to send the indication to the MS via a forward packet data control channel (F-PDCCH) of the serving cell.

48. A mobile station (MS) comprising:
a transceiver;
a processor, communicatively coupled to the transceiver,
adapted to receive, via the transceiver, data transmission service from a serving cell via a forward link of the serving cell;
adapted to determine to switch from the serving cell to a target cell for data transmission service via a forward link of the target cell;
adapted to transmit, via the transceiver, an indication of the MS's intent to switch to the target cell;
adapted to receive, via the transceiver, an indication that the target cell is presently unavailable to provide data transmission service to the MS via the forward link the target cell.

49. The MS of claim 48,
wherein the indication that the target cell is presently unavailable to provide data transmission service to the MS via the forward link of the target cell comprises a Universal Handoff Direction message (UHDM) that indicates that the target cell does not support a forward link.

50. The MS of claim 48,
wherein the indication that the target cell is presently unavailable to provide data transmission service to the MS via the forward link of the target cell comprises a Universal Handoff Direction message (UHDM) that indicates that the target cell is not part of an active set of the MS.

51. The MS of claim 48,
wherein adapted to receive the indication that the target cell is currently unavailable to provide data transmission service to the MS via the forward link of the target cell comprises adapted to receive the indication by the MS via a forward packet data control channel (F-PDCCH) of the serving cell.
